(19) United States
(12) Patent Application Publication
(10) Pub. No.: US 2008/0293349 A1
(43) Pub. Date: Nov. 27, 2008

(54) AUTOMOTIVE CLIMATE CONTROL SYSTEM AND METHOD FOR EXHAUST ODOR ABATEMENT

(76) Inventor: Charles Francis Weber, Dexter, MI (US)

Correspondence Address: VISTEON/BRINKS HOFER GILSON & LIONE, 524 South Main Street, Suite 200, Ann Arbor, MI, 48104, US

(21) Appl. No.: 11/751,893

(22) Filed: May 22, 2007

(51) Int. Cl. B60H 1/26

(52) U.S. Cl. 454/75

(57) ABSTRACT

A climate control system and method for preventing exhaust odors from entering the passenger compartment of a motor vehicle. The climate control system includes a duct network and a damper system that is moveable between a fresh air mode and a recirculation air mode. The damper system being moved based at least in part upon a vehicle acceleration condition. During operation, the system is operated in the recirculation air mode during acceleration in a situation that probably has a high concentration of the exhaust odor and gases. The system operates in the fresh air mode when the situation is one that does not have a high probability of a high concentration of exhaust odors and gases.

### BACKGROUND

1. Field of Invention

The present invention relates generally to climate control systems and, more particularly, to an automotive climate control system which prevents exhaust odors from entering the passenger compartment of a vehicle.

2. Related Technology

Climate control systems in automotive vehicles serve many important functions. One function is to provide comfortable conditions for occupants within the vehicle. In operation, automotive climate control systems circulate outside air to vehicle passengers. This air may contain unpleasant engine exhaust odors from other surrounding vehicles.

Current climate control systems may use an odor detection sensor to prevent unpleasant exhaust odors from entering the passenger compartment of the vehicle. If unacceptable outside air exists, based on odor detection, the climate control system rejects outside air and re-circulates the interior air. When the unpleasant exhaust odor condition is passed, the air mode is reset to accept fresh outside air for passengers. This method, however, bears the cost of the odor detection sensor.

Alternatively, climate control systems may use a contaminant sensor coupled with a filtration system. Upon indication of contaminants entering the air flow into a vehicle interior, the climate control system causes the air flow to pass through a filter or a decontamination module to clean the air. The decontaminated air is then supplied to the vehicle interior. Once the conditions have improved, the climate control system detects the satisfactory conditions and the air is no longer caused to pass through the decontamination module. This method, however, bears the high cost of the contaminant sensor and filtration system.

Thus, a need exists for an efficient and cost effective climate control system and method for preventing unpleasant odors, such as exhaust odors, from entering the passenger compartment of a vehicle.

### SUMMARY

In satisfying the above need, as well as overcoming the enumerated drawbacks and other limitations of the related art, the present invention provides an automotive climate control system that optimizes occupant comfort by preventing unpleasant odors, such as exhaust odors, from entering the vehicle passenger compartment while minimizing system costs.

The invention is based on the understanding that concentrations of exhaust odors surrounding a vehicle are highest in places where vehicles accelerate. During acceleration, exhaust gas flow can be an order of magnitude greater than cruising, and two orders of magnitude greater than idling. When an accelerating automobile follows other accelerating automobiles, it is exposed to high concentrations of exhaust. Acceleration in these instances is most likely to occur when vehicles pull away from intersections. Exhaust concentration is further increased at intersections because accelerating vehicles are initially slow moving with large exhaust flows. Additionally, there can be multiple, closely spaced, forwardly located vehicles simultaneously accelerating on a new green traffic light. The combination of these common factors is the worst case scenario for exhaust concentrations in outside air. Therefore, to prevent unpleasant exhaust odors from entering the passenger compartment of a vehicle, the mode of operation of the climate control system of the present invention is dependent upon vehicle acceleration, when exhaust odor from traffic is most likely.

The automotive climate control system includes a duct network, which may house an evaporator, a heater, and a blower. The duct network includes a fresh air intake located so as to intake outside air, an interior air intake located so as to intake recirculation air, and an air outtake for supplying air to the passenger compartment. The blower causes the air from the fresh air intake and/or the interior air intake to move across the evaporator and heater, through the air outtake, and into the passenger compartment. The climate control system further includes an electronic climate control module (ECCM) and a damper door configured to selectively operate the system in fresh air mode (where the damper door closes the interior air intake permitting air passage through the fresh air intake) or recirculation air mode (where the damper door closes the fresh air intake permitting air passage through the interior air intake).

Further, the ECCM is configured to determine vehicle acceleration based at least in part on a signal from a vehicle speed determining system. The vehicle speed determining system may include a speed sensor, an accelerometer, a vehicle navigation system, a global positioning sensor system or any suitable means for obtaining speed information from a vehicle network. Upon the detection of vehicle acceleration and other acceptable climate control system conditions permitting re-circulated air to enter the passenger compartment of the vehicle, the ECCM will operate the climate control system in recirculation air mode, thereby rejecting outside air likely to be contaminated with unpleasant exhaust odors. The ECCM will switch the mode of operation to fresh air mode after acceleration reaches a low threshold and a dwell time has passed, thus permitting outside air to enter the passenger compartment of a vehicle. This occurs when the vehicle is likely to be surrounded by a low concentration of exhaust odors.

One advantage of the present invention is the cost-effective ability to optimize passenger comfort. The system improves the quality of air inside a vehicle using speed data from a vehicle speed determining system and an ECCM. Interior air is re-circulated based on a vehicle acceleration condition, thus eliminating the costs of an odor detection sensor and/or a special filtration system.

In at least one embodiment, the automotive climate control system comprises a duct network including a fresh air intake (that receives air from outside the vehicle), an interior air intake (that receives air from the passenger compartment of the vehicle), and an air outtake (that provides air to the passenger compartment of the vehicle). The duct network further includes a damper system that is moveable between a fresh air mode and a recirculation air mode. In the fresh air mode, the damper system generally prevents the passage of air into the duct network from the interior air intake. In the recirculation air mode, the damper system generally prevents the passage of air into the duct network from the fresh air intake.

A controller is coupled to the damper and configured to cause movement of the damper system between the fresh air mode and the recirculation air mode. The controller is configured to operate the climate control system in the fresh air mode upon the detection of a first condition that is based at least in part upon a vehicle acceleration condition. The controller is configured to operate the climate control system in the recirculation air mode upon the detection of a second condition that is based at least in part upon a vehicle acceleration condition.

In another embodiment, the controller is configured to determine vehicle acceleration based at least in part on a signal from a vehicle speed determining system. The vehicle speed determining system may include a speed sensor, an accelerometer, a vehicle navigation system, or a global positioning sensor system.

In another embodiment, the controller is configured to operate the climate control system in the fresh air mode upon the detection of a first condition that is based at least in part upon a vehicle acceleration condition, where the vehicle acceleration condition is acceleration below a threshold limit or no acceleration.

In another embodiment, the controller is configured to operate the climate control system in the fresh air mode upon the detection of a first condition that is based at least in part upon a time condition, where the time condition is expiration of a timer.

In another embodiment, the controller is configured to operate the climate control system in the fresh air mode upon the detection of a first condition that is based at least in part upon a vehicle acceleration condition and at least in part upon a time condition, where the vehicle acceleration condition is acceleration below a threshold limit and the time condition is the expiration of a timer.

In another embodiment, the controller is configured to operate the climate control system in the recirculation air mode upon the detection of a second condition that is based at least in part upon a vehicle acceleration condition, where the vehicle acceleration condition is the existence of acceleration or acceleration above a threshold limit.

In another aspect, the present invention provides a method of operating a climate control system to prevent exhaust odor from entering the passenger compartment of the vehicle. The climate control system includes a fresh air intake, an interior air intake, and an air outtake, a damper system and a controller. The method of the present invention includes determining vehicle acceleration. The method further includes detecting a first condition based at least in part upon a vehicle acceleration condition. Upon detecting the first condition, the climate control system operates in a fresh air mode to accept outside air through the fresh air intake and provide the outside air to the passenger compartment of the vehicle.

The method further includes detecting a second condition based at least in part upon a vehicle acceleration condition. Upon detecting the second condition, the climate control system operates in a recirculation air mode to accept recirculation air from the interior air intake and provide the recirculation air to the passenger compartment of the vehicle.

In another aspect, the method of operating a climate control system for a vehicle includes detecting a first condition based at least in part on a vehicle acceleration condition, where the step of detecting the first condition includes determining if acceleration is below of threshold limit or if no acceleration exists. The step of detecting the first condition may also be based at least in part on a time condition.

In another aspect, the method of operating a climate control system for a vehicle includes detecting a first condition based at least in part upon a vehicle acceleration condition and at least in part upon a time condition, where the step of detecting the first condition includes determining if the vehicle acceleration is below a threshold limit and if a timer has expired.

In another aspect, the method of operating a climate control system for a vehicle includes detecting a second condition based at least in part on a vehicle acceleration condition, where the step of detecting the second condition includes determining if acceleration exists or if acceleration exists above a threshold limit.

### BRIEF DESCRIPTION OF THE DRAWINGS

FIG. 1 is a schematic illustration of a vehicle climate control system embodying the principles of the present invention; and

FIG. 2 is a flow chart depicting operation of the system according to the present invention.

### DETAILED DESCRIPTION

The following description of the preferred embodiment of the invention is not intended to limit the scope of the invention to this preferred embodiment, but rather to enable any person skilled in the art to make and use the invention.

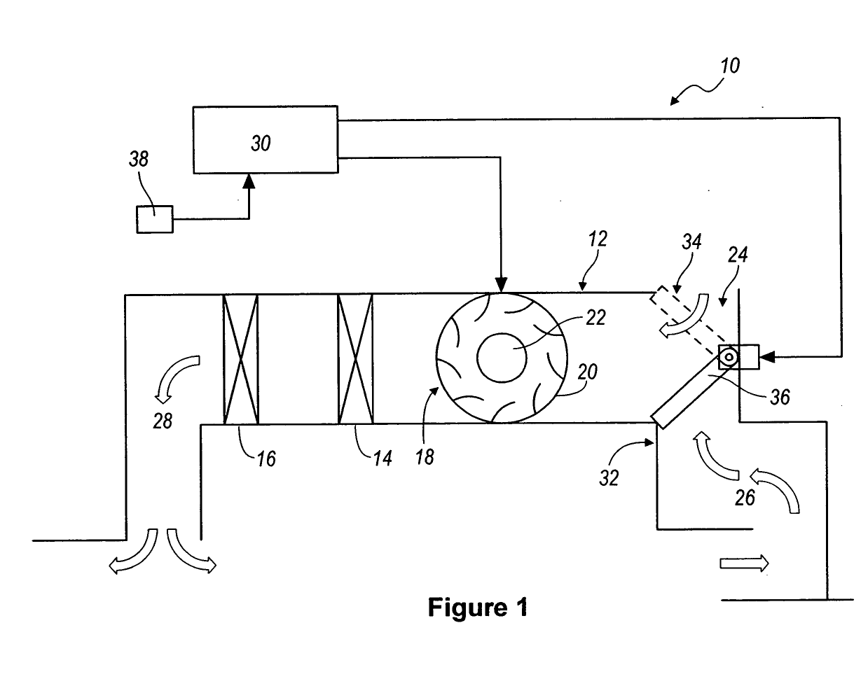

Referring now to FIG. 1, illustrated therein is a portion of a vehicle climate control system 10 for providing fresh or recirculation air so as to minimize exhaust odors in the passenger compartment of the vehicle at various driving situations. The climate control system 10 includes a housing or duct network 12, which surrounds one or more of an evaporator 14, a heater 16, and a blower 18, the latter of which may comprise a fan 20 and a motor 22 to blow air across the evaporator 14 and heater 16. The duct network 12 is provided with a fresh air intake 24 for outside air, an interior air intake 26 for recirculation air, and an air outtake 28 for supplying air to the passenger compartment of the vehicle.

The climate control system 10 further includes a programmable electronic climate control module (ECCM) 30 configured to selectively operate the climate control system 10 in fresh air mode 32 or recirculation air mode 34.

During operation in fresh air mode 32, the interior air intake 26 is closed off and the fresh air intake 24 is open so that the air supplied to the passenger compartment via the air outtake 28 is fresh air from the fresh air intake 24. Conversely, during operation in recirculation air mode 34, the fresh air intake 24 is closed off and the interior air intake 26 is open such that outside air is rejected and interior air is re-circulated to the passenger compartment through the air outtake 28.

To control whether the climate control system 10 operates in fresh air mode 32 or recirculation air mode 34, the ECCM 30 is configured to actuate a damper door 36 to close off the interior air intake 26 or the fresh air intake 24, respectively, during various driving situations.

FIG. 1 shows a first operating condition set by the ECCM 30 through its actuation of the damper door 36. This operation condition is characterized by operation in the fresh air mode 32, wherein the pivotally mounted damper door 36 is positioned to prevent air passage through the interior air intake 26 and to permit air passage through the fresh air intake 24 when the driving condition so demands.

FIG. 1 further illustrates (in phantom) a second operating condition characterized by operation in the recirculation air mode 34, wherein the pivotally mounted damper door 36 is positioned to prevent air passage through the fresh air intake 24 and permit air passage through the interior air intake 26. Operating the climate control system 10 in recirculation air mode 34 is particularly useful when, for example, a vehicle is accelerating out of an intersection. As noted above, this situation is when the outside concentration of exhaust gas from surrounding vehicles is typically greatest.

In order to detect such a driving condition, the ECCM 30 receives vehicle speed data from a vehicle speed sensor 38. Based in part on the output of the vehicle speed sensor 38, the ECCM 30 determines if the vehicle is potentially in a situation where the concentration of exhaust gas in the air surrounding the vehicle is at an unacceptable level or if the vehicle is most likely in a situation where the concentration of exhaust gas in the air surrounding the vehicle is at an acceptable level.

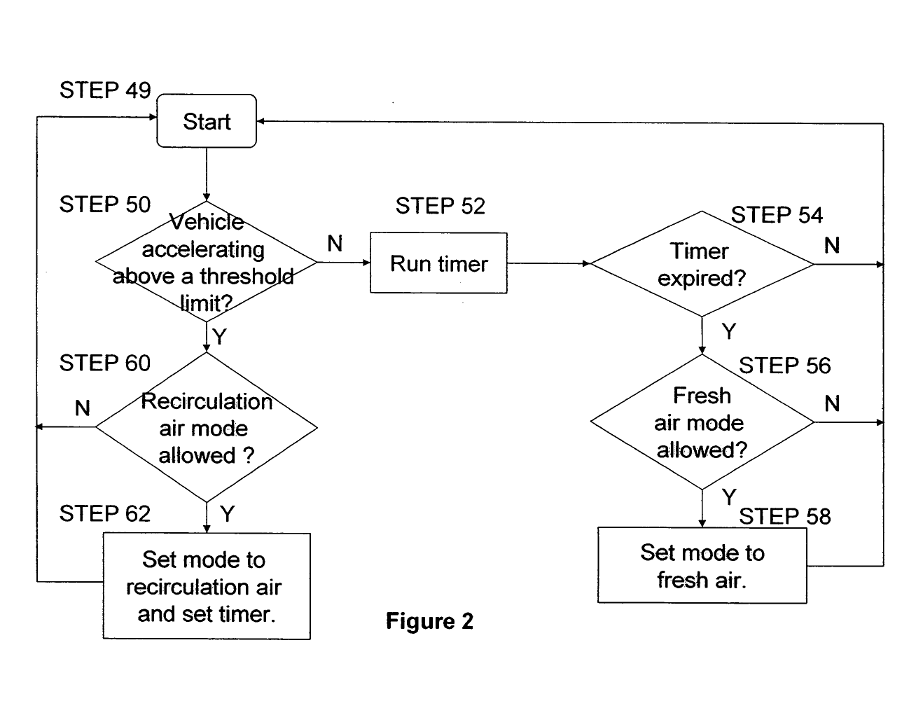

FIG. 2 depicts a flow diagram representative of program instructions executed by the ECCM 30 for carrying out the above-described control in the context of a system in which the operating air mode is varied between the fresh air mode 32 and the recirculation air mode 34, based on vehicle acceleration. This process is repeatedly executed while the climate control system 10 is being operated.

The method starts at STEP 49 and proceeds to determine vehicle acceleration, as indicated at STEP 50. The acceleration is based at least in part on speed data from a vehicle speed determining system. For example, a vehicle speed sensor, an accelerometer, a vehicle navigation system, or a global positioning sensor system may provide vehicle speed information to the ECCM 30 so that the ECCM 30 can determine if the vehicle is accelerating above a threshold limit. When the ECCM 30 determines that the vehicle is accelerating below a threshold limit, and thus probably not in the presence of high concentrations of outside exhaust odors, it sends a signal to run a timer 40, as indicated at STEP 52. At STEP 54, the ECCM 30 determines whether the timer 40 has expired. If the timer 40 has not expired, the process returns to STEP 49 and re-checks the vehicle acceleration. If the vehicle acceleration condition is still below a threshold limit, the timer 40 continues to run, as indicated at STEP 52. Alternatively, if the ECCM 30 determines that the timer 40 has expired, the ECCM 30 next determines whether the fresh air mode is allowed at STEP 56. Subject to other acceptable climate control system conditions permitting outside air to enter the passenger compartment of the vehicle as determined in STEP 56, the ECCM 30 will either return to STEP 49 (if the answer is “No”) or set the climate control system 10 to fresh air mode 32 (if the answer is “Yes”) as indicated at STEP 58. Thereafter the method returns to start (STEP 49) and the method begins again. Therefore, provided that the vehicle acceleration is below a threshold limit and a dwell time has passed and hence the vehicle is likely to be surrounded by a low concentration of exhaust doors, and if other acceptable climate control system conditions allow fresh air to enter the vehicle, the ECCM 30 will operate the climate control system 10 in fresh air mode 32 and permit the passage of fresh outside air into the passenger compartment of the vehicle.

Conversely, if STEP 50 reveals that the vehicle is accelerating above a threshold limit, and thus likely surrounded by a high concentration of exhaust odors, the ECCM 30 will move to STEP 60 to determine whether the recirculation air mode 34 is allowed. If other acceptable climate control system conditions do not permit the system 10 to enter the recirculation air mode 34, then the method returns to start (STEP 49) and begins again. If the other climate control system conditions do permit re-circulated air to enter the passenger compartment of the vehicle, then the ECCM 30 will set the climate control system 10 to recirculation air mode 34 and set a timer 40, as indicated by STEP 62. Thereafter the method returns to start (STEP 49) and the method begins again. As long as acceleration remains above a threshold value (based on design criteria of the system), the system 10 will remain in the recirculation air mode 34. Therefore, provided that the vehicle is accelerating above a threshold limit and thus likely to be surrounded by a high concentration of exhaust odors, if other acceptable climate control system conditions allow recirculation air to enter the passenger compartment of the vehicle, the ECCM 30 will operate the climate control system 10 in recirculation air mode 34 and re-circulate the interior air to the passenger compartment.

Thus, the ECCM 30 adjusts the air mode of operation of the climate control system 10 between fresh air mode 32 and recirculation air mode 34, to improve air quality for vehicle passengers, by rejecting outside air and re-circulating interior air during vehicle acceleration when the anticipated concentration of surrounding exhaust odors is highest. This control, based on vehicle acceleration, thereby provides both an effective and cost efficient climate control system 10.

Alternative embodiments other than those described above may be used with the present invention. It is therefore intended that the foregoing detailed description be regarded as illustrative rather than limiting, and that it be understood that it is the following claims, including all equivalents, that are intended to define the spirit and scope of this invention.

What is claimed is:

1. A climate control system for preventing outside engine exhaust odors from entering the passenger compartment of a motor vehicle, the climate control system comprising:
a duct network including a fresh air intake that receives air from outside the vehicle, an interior air intake that receives air from the passenger compartment of the vehicle, an air outtake that provides air to the passenger compartment of the vehicle, and a damper system moveable between a fresh air mode and a recirculation air mode, in the fresh air mode the damper system generally preventing the passage of air into the duct network from the interior air intake, in the recirculation air mode the damper system generally preventing the passage of air into the duct network from the fresh air intake; and
a controller coupled to the damper and configured to cause movement of the damper system between the fresh air mode and the recirculation air mode, the controller being configured to operate the climate control system in the fresh air mode upon the detection of a first condition that is based at least in part upon a vehicle acceleration condition, the controller being configured to operate the climate control system in the recirculation air mode upon the detection of a second condition that is based at least in part upon a vehicle acceleration condition.

2. The climate control system of claim 1 wherein the controller is configured to determine vehicle acceleration based at least in part on a signal from a vehicle speed determining system.

3. The climate control system of claim 2 wherein the vehicle speed determining system includes one of a speed sensor, accelerometer, a vehicle navigation system, and a global positioning system.

4. The climate control system of claim 1 wherein the first condition is based at least in part on the vehicle acceleration condition and the vehicle acceleration condition is acceleration below a threshold limit.

5. The climate control system of claim 1 wherein the first condition is based at least in part on the vehicle acceleration condition and the vehicle acceleration condition is no acceleration.

6. The climate control system of claim 1 wherein the first condition is based at least in part upon a time condition.

7. The climate control system of claim 6 wherein the time condition is expiration of a timer.

8. The climate control system of claim 1 wherein the first condition is based at least in part on the vehicle acceleration condition and a time condition, the vehicle acceleration condition being acceleration below a threshold limit and the time condition being the expiration of a timer.

9. The climate control system of claim 1 wherein the second condition is based at least in part on the vehicle acceleration condition and the vehicle acceleration condition is the existence of acceleration.

10. The climate control system of claim 9 wherein the vehicle acceleration condition is the existence of acceleration above a threshold limit.

11. A method of operating an automotive climate control system to prevent exhaust odor from entering the passenger compartment of a vehicle, the climate control system including a fresh air intake, an interior air intake, an air outtake, a damper system and a controller, the method comprising the steps of:
determining vehicle acceleration;
detecting a first condition based at least in part upon a vehicle acceleration condition;
upon detecting the first condition, operating the climate control system in a fresh air mode to accept outside air through the fresh air intake and provide the outside air to the passenger compartment of the vehicle;
detecting a second condition based at least in part upon a vehicle acceleration condition; and
upon detecting the second condition, operating the climate control system in a recirculation air mode to accept recirculation air from the interior air intake and provide the recirculation air to the passenger compartment of the vehicle.

12. The method of claim 11 wherein the step of detecting the first condition based at least in part on the vehicle acceleration condition includes determining if acceleration is below a threshold limit.

13. The method of claim 11 wherein the step of detecting the first condition based at least in part on the vehicle acceleration condition includes determining if no acceleration exists.

14. The method of claim 11 wherein the step of detecting the first condition is also based at least in part on a time condition.

15. The method of claim 14 wherein the step of detecting the first condition includes determining if vehicle acceleration is below a threshold limit and if a timer has expired.

16. The method of claim 11 wherein the step of detecting the second condition based at least in part on the vehicle acceleration condition includes determining if acceleration exists.

17. The method of claim 11 wherein the step of detecting the second condition based at least in part upon the vehicle acceleration condition includes determining if acceleration exists above a threshold limit.
